(19) United States
(12) Patent Application Publication
(10) Pub. No.: US 2014/0339732 A1
(43) Pub. Date: Nov. 20, 2014

(54) MOLDED ARTICLE MANUFACTURING APPARATUS, METHOD OF MANUFACTURING MOLDED ARTICLE, AND MOLDED ARTICLE

(71) Applicant: Toshiba Kikai Kabushiki Kaisha, Tokyo (JP)

(72) Inventor: Nobuyuki ASANUMA, Numazu-shi (JP)

(73) Assignee: Toshiba Kikai Kabushiki Kaisha, Tokyo (JP)

(21) Appl. No.: 14/278,286

(22) Filed: May 15, 2014

(30) Foreign Application Priority Data
May 15, 2013 (JP) 2013-103070
Apr. 4, 2014 (JP) 2014-078132

(51) Int. Cl. B29C 45/14

(52) U.S. Cl. CPC B29C 45/14065; B29C 2045/14147
USPC 264/266; 425/112

(57) ABSTRACT

A molded article manufacturing apparatus includes a conveying device configured to convey an insert member in a vertical attitude, and a die including a positioning pin configured to pierce the insert member which has been conveyed by the conveying device.

### CROSS-REFERENCE TO RELATED APPLICATIONS

This application is based upon and claims the benefit of priority from Japanese Patent Application No. 2013-103071, filed May 15, 2013, and Japanese Patent Application No. 2014-078132, filed Apr. 4, 2014 the entire contents of all of which are incorporated herein by reference.

### BACKGROUND OF THE INVENTION

1. Field of the Invention

The present invention relates to a molded article manufacturing apparatus, a method of manufacturing a molded article, and a molded article for manufacturing the molded article by using an insert member.

2. Description of the Related Art

Conventionally, there is known a technique in which a thermoplastic prepreg, which is an insert member, is inserted into a die and pressed, thereby shaping the thermoplastic prepreg and manufacturing a molded article.

There is also known a molded article manufacturing technique in which a thermoplastic prepreg is shaped, and further, a molded part, such as a boss or a rib, is formed by injection molding.

The thermoplastic prepreg is formed of a fabric material and a thermoplastic resin material in a sheet shape, and the thermoplastic prepreg can be shaped by heating. As regards the heating of the thermoplastic prepreg, there is known a molded article manufacturing apparatus which is configured such that a thermoplastic prepreg is conveyed to a heating device and a die by a conveying device which conveys the thermoplastic prepreg by placing it on conveying means in a horizontal attitude.

In addition, when the thermoplastic prepreg is inserted into the die, the thermoplastic prepreg is positioned by inserting a positioning pin, which is provided on the die, into a positioning hole which is provided in advance in the thermoplastic prepreg.

Further, for example, Jpn. Pat. Appln. KOKAI Publication No. H6-270199 discloses a technique in which a conveying head, which can hold an insert member, such as a thermoplastic prepreg, by vacuum suction means or the like, is used as a conveying device for conveying the insert member. The conveying device using this conveying head is formed such that the conveying device can convey the insert member, with the direction of this insert member being changed, by rotating and moving a movable arm on which the conveying head is provided.

In the above-described molded article manufacturing methods, the thermoplastic prepreg is, after being heated, inserted into the die. Thus, the thermoplastic prepreg itself has been softened (set in a softened state) and has viscosity. Hence, if the above-described conveying device is used, there is a concern that the thermoplastic prepreg moves relative to the conveying head at a time of delivery, and misregistration will occur.

If misregistration occurs when the positioning pin provided on the die is inserted into the positioning hole in the thermoplastic prepreg and the thermoplastic prepreg is inserted into the die, there is a concern that the thermoplastic prepreg will fall.

Furthermore, if a resin material of a thermoplastic prepreg, which was melted in a preceding cycle, adheres to that part of the conveying device, which is in contact with a thermoplastic prepreg, there is a concern that the positioning pin is not inserted into the positioning hole by a predetermined amount of insertion, and the thermoplastic prepreg will fall.

In order to prevent such falling of the thermoplastic prepreg, it is possible to perform the insert operation at a low speed, thereby preventing misregistration. However, there arises a problem that the molding cycle becomes longer.

### BRIEF SUMMARY OF THE INVENTION

According to an embodiment of the present invention, a molded article manufacturing apparatus includes a conveying device configured to convey an insert member in a vertical attitude, and a die including a positioning pin configured to pierce the insert member which has been conveyed by the conveying device.

According to an embodiment of the present invention, a method of manufacturing a molded article includes conveying an insert member in a vertical attitude by a conveying device to a die including a positioning pin, piercing the insert member, which has been conveyed by the conveying device, by the positioning pin, and forming the insert member by the die.

According to an embodiment of the present invention, a molded article is molded by conveying an insert member in a vertical attitude by a conveying device to a die including a positioning pin, piercing the insert member, which has been conveyed by the conveying device, by the positioning pin, and forming the insert member by the die.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view which schematically illustrates the structure of a molded article manufacturing apparatus according to an embodiment of the invention.

FIG. 2 is a front view which schematically illustrates a main structure used in the molded article manufacturing apparatus.

FIG. 3 is a side view which schematically illustrates a main structure used in the molded article manufacturing apparatus.

FIG. 4 is a cross-sectional view which schematically illustrates a main structure used in the molded article manufacturing apparatus, this structure relating to a fabrication process of a molded article.

FIG. 5 is a cross-sectional view which schematically illustrates a main structure used in the molded article manufacturing apparatus, this structure relating to a fabrication process of a molded article.

FIG. 6 is a cross-sectional view which schematically illustrates a main structure used in the molded article manufacturing apparatus, this structure relating to a fabrication process of a molded article.

FIG. 7 is a front view illustrating an example of an insert member used in the molded article manufacturing apparatus.

### DETAILED DESCRIPTION OF THE INVENTION

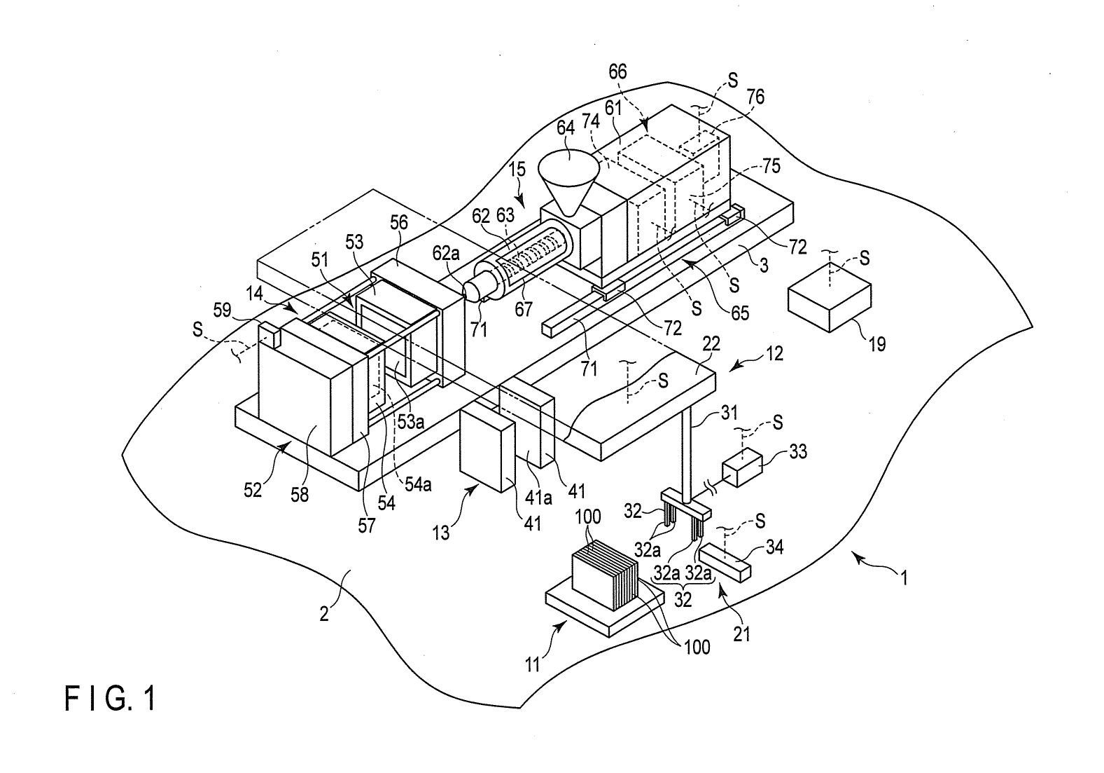

A molded article manufacturing apparatus 1 according to an embodiment of the present invention will be described hereinafter with reference to FIG. 1 to FIG. 6.

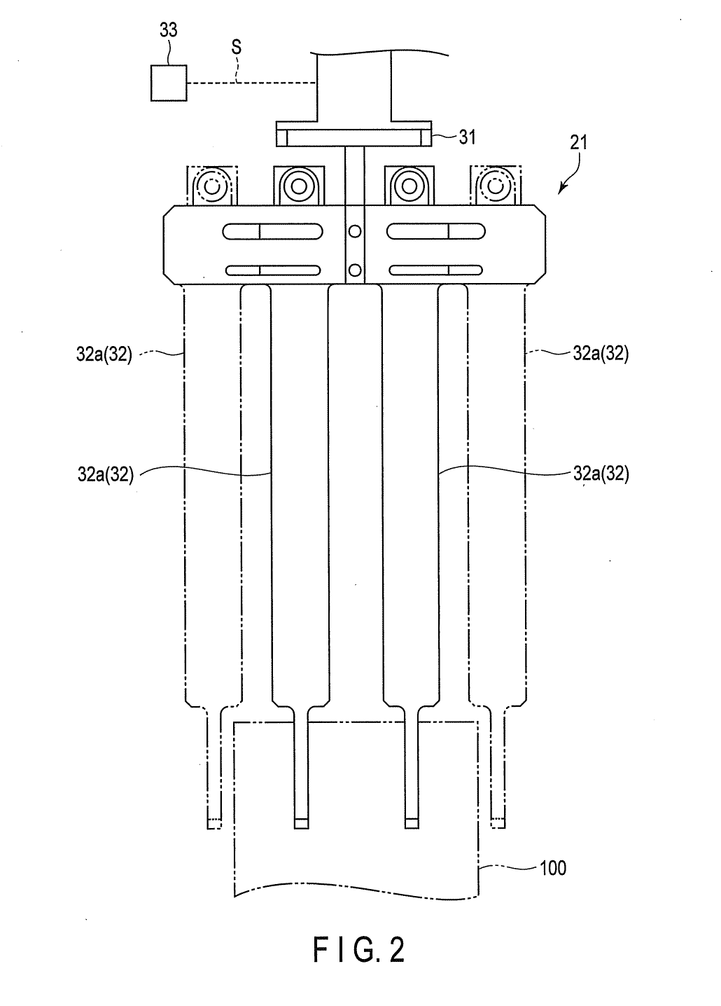

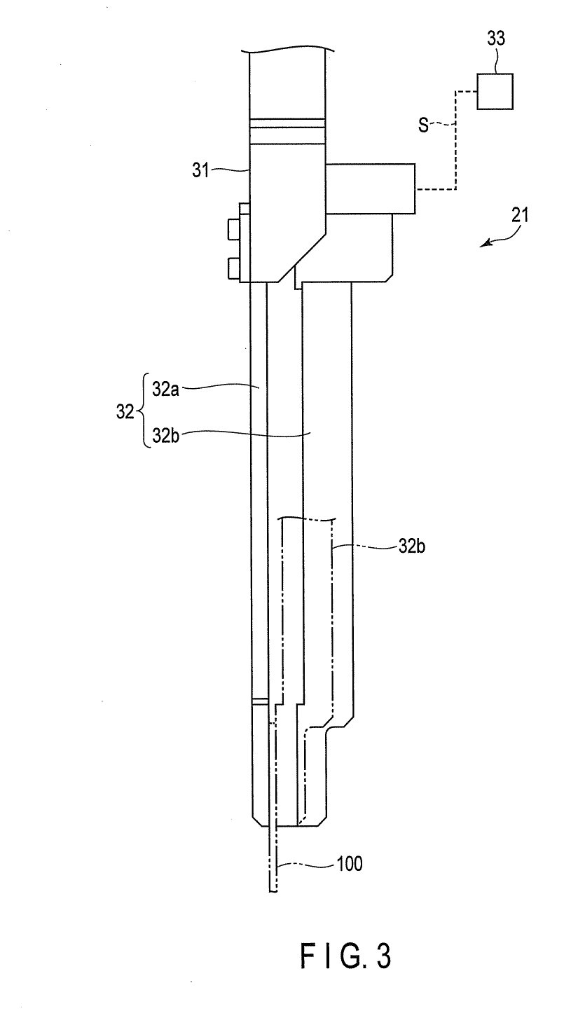

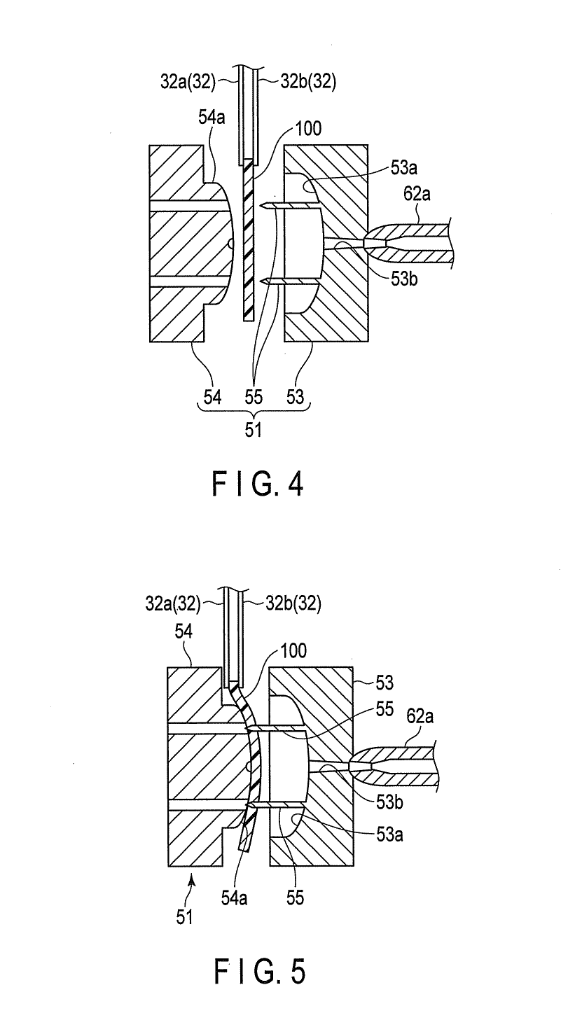

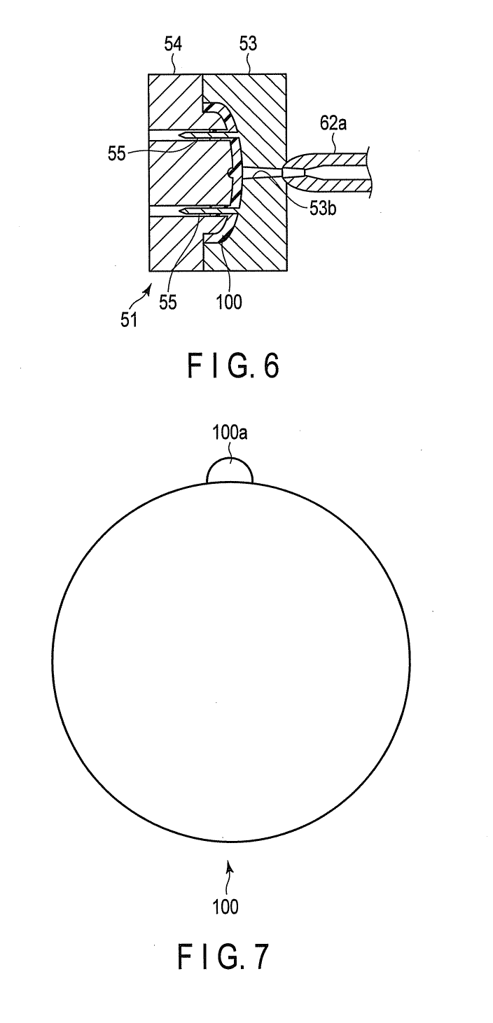

FIG. 1 is a perspective view which schematically illustrates the structure of the molded article manufacturing apparatus 1 according to an embodiment of the present invention. FIG. 2 is a front view which schematically illustrates a main structure used in the molded article manufacturing apparatus 1, and more specifically, the structure of chucks 32. FIG. 3 is a side view which schematically illustrates the structure of the chucks 32. FIG. 4 is a cross-sectional view which schematically illustrates a main structure used in the molded article manufacturing apparatus 1, and more specifically, the structure of chucks 32, a die 51 and a thermoplastic prepreg 100, this structure relating to a fabrication process of a molded article. FIG. 5 is a cross-sectional view which schematically illustrates the structure of the chucks 32, die 51 and thermoplastic prepreg 100, this structure relating to a fabrication process of the molded article. FIG. 6 is a cross-sectional view which schematically illustrates the structure of the die 51 and thermoplastic prepreg 100, this structure relating to a fabrication process of the molded article.

As illustrated in FIG. 1, the molded article manufacturing apparatus 1 includes, for example, a storage section 11, a conveying device 12, a heating device 13, a mold device 14, an injection device 15, and a control device 19. The molded article manufacturing apparatus 1 is disposed in an installation range 2 in a factory, etc., and the mold device 14 and injection device 15 are disposed on a base 3. The molded article manufacturing apparatus 1 is configured to be able to manufacture a molded article, by heating the thermoplastic prepreg 100 that is an insert member, shaping thereafter the thermoplastic prepreg 100 by the mold device 14 and injecting the resin material in the die 51 by the injection device 15.

The thermoplastic prepreg 100 that is the insert member is formed in a sheet shape. The thermoplastic prepreg 100 is formed of a fabric material, such as glass or carbon, and a thermoplastic resin material. The thermoplastic prepreg 100 is configured to have a rectangular plan-view shape in FIG. 1, but the thermoplastic prepreg 100 may be formed in any shape suitable for the shaping into the shape of a molded article. The thermoplastic prepreg 100 is formed, for example, in a rectangular shape, a triangular shape, an elliptic shape, or a different shape in which the molded article can be formed.

The storage section 11 is configured to be able to store a plurality of thermoplastic prepregs 100. The storage section 11 is configured to be able to store the thermoplastic prepregs 100, for example, in a vertical attitude. In the meantime, the storage section 11 may be formed, for example, such that the storage section 11 stores thermoplastic prepregs 100 in a horizontal attitude and can change the attitude of the thermoplastic prepregs 100 from the horizontal attitude to the vertical attitude.

In this case, the vertical attitude of the thermoplastic prepreg 100 is an attitude in which a major surface of the thermoplastic prepreg 100 is substantially in the direction of gravity, that is, an attitude in which the major surface of the thermoplastic prepreg 100 extends in an up-and-down direction, or an attitude equal to these attitudes. In addition, the horizontal attitude of the thermoplastic prepreg 100 is an attitude in which a major surface of the thermoplastic prepreg 100 is substantially in the horizontal direction, that is, an attitude in which the major surface of the thermoplastic prepreg 100 extends along the surface of installation of the molded article manufacturing apparatus 1, or an attitude equal to these attitudes.

The conveying device 12 is formed such that the thermoplastic prepregs 100 can be successively conveyed in their vertical attitude from the storage section 11 of thermoplastic prepregs 100 to the heating device 13 and mold device 14. Specifically, the conveying device 12 includes a chuck device 21 and a conveying mechanism 22.

The chuck device 21 includes, for example, a support portion 31 which is provided on the conveying mechanism 22, a plurality of chucks 32, opening/closing means 33 for opening/closing the chucks 32, and a cooling device 34. The chuck device 21 is configured to be able to clamp the thermoplastic prepreg 100 at a plurality of positions by the plural chucks 32.

As is illustrated in FIG. 2 and FIG. 3, the support portion 31 is configured to be able to support the plural chucks 32. The support portion 31 is configured to be movable by the conveying mechanism 22. As shown in FIG. 2 and FIG. 3, the chuck 32 is formed such that the chuck 32 can open/close its distal end portion by being driven by the opening/closing means 33. The chuck 32 is formed such that at least the width of the distal end, which holds the thermoplastic prepreg 100, is reduced. In addition, the plural chucks 32 are supported on the support portion 31 such that the distance between the chucks 32 can be adjusted, as indicated by solid lines and two-dot-and-dash lines in FIG. 2.

The chuck 32 is composed of, for example, a fixed claw portion 32a provided on the support portion 31, and a movable claw portion 32b which moves toward or away from the fixed claw portion 32a. The movable claw portion 32b is driven by the opening/closing means 33. The fixed claw portion 32a and movable claw portion 32b are formed of, for example, a material with good heat resistance. The fixed claw portion 32a and movable claw portion 32b are formed of, for example, a stainless steel material, aluminum material, etc.

In the state in which an end portion of the thermoplastic prepreg 100 is positioned between the distal ends of the fixed claw portion 32a and movable claw portion 32b, the movable claw portion 32b is driven by the opening/closing means 33, and the chuck 32 is set in the closed state. The chuck 32 is configured to be able to hold the thermoplastic prepreg 100 by the closed state being maintained. The chuck 32 is formed in such a shape that the chuck 32 does not interfere with the die 51 when the chuck 32 conveys the thermoplastic prepreg 100 to the die 51 and inserts the thermoplastic prepreg 100 into the die 51.

For example, the chuck 32 is formed such that the width between outer surfaces of the fixed claw portion 32a and movable claw portion 32b is short, and the length thereof is large. The chuck 32 is formed such that a long distance of movement can be secured from the open state to the closed state of the die 51 until the chuck 32 interferes with the die 51, when the thermoplastic prepreg 100 is inserted into the die 51. The chuck 32 is configured, for example, such that only the fixed claw portion 32a and movable claw portion 32b are opposed to the die 51.

The opening/closing means 33 is a driving source configured to open/close the chucks 32 by moving the movable claw portions 32b and, for example, a pneumatic cylinder or the like is used as the opening/closing means 33. The opening/closing means 33 is electrically connected to the control device 19 via a signal line S.

The cooling device 34 is configured to be able to cool the chucks 32. The cooling device 34 is configured to be able to cool the chucks 32, for example, by jetting air to the chucks 32. The cooling device 34 is electrically connected to the control device 19 via a signal line S.

The cooling device 34 is configured to be able to cool at least those parts of the fixed claw portion 32a and movable claw portion 32b, which come in contact with the thermoplastic prepreg 100, and peripheral areas of such parts. The cooling device 34 is supported by the support portion 31, or is disposed at such a position that the cooling device 34 can cool the chucks 32 in a fabrication process before the chucks 32 move to the storage section 11.

The conveying mechanism 22 is a mechanism for successively conveying the chucks 32 of the chuck device 21 to the storage section 11, heating device 13 and mold device 14 and, for example, the conveying mechanism 22 is configured to be able to slidably move the support portion 31. The conveying mechanism 22 is, for example, a rail or an articulated robot. The conveying mechanism 22 is electrically connected to the control device 19 via a signal line S.

As illustrated in FIG. 1, the heating device 13 includes a pair of heating portions 41 which are opposed to each other with a distance therebetween, the pair of heating portions 41 being capable of heating the thermoplastic prepreg 100. The pair of heating portions 41 have heating surfaces 41a for heating the thermoplastic prepreg 100, the heating surfaces 41a being disposed along the major surfaces of the thermoplastic prepreg 100.

Specifically, the paired heating portions 41 are disposed in the vertical attitude. The paired heating portions 41 are opposed to each other with such an interval that parts of the distal end portions of the fixed claw portion 32a and movable claw portion 32b of the chucks 32 and the thermoplastic prepreg 100, which is held by the chucks 32, can pass through.

For example, the heating portions 41 are formed such that one or plural infrared heaters are provided on the mutually opposed heating surfaces 41a of the heating portions 41, thus being able to heat up to a predetermined temperature the thermoplastic prepreg 100 which passes between the heating portions 41 or is at rest between the heating portions 41. Incidentally, the predetermined temperature, in this context, means such a temperature that the thermoplastic prepreg 100 can be shaped in the mold device 14.

The mold device 14 includes an openable/closable die 51, and a mold clamping device 52 which opens/closes the die 51.

The die 51 includes, for example, a fixed die 53, a movable die 54, and a positioning pin 55. The fixed die 53 has a cavity 53a which is formed in a shape corresponding to a part of a molded article, and a gate 53b which is continuous with the cavity 53a and is formed on a surface facing the injection device 15, on that surface of the fixed die 53, which is opposed to the movable die 54. The movable die 54 is configured to be movable relative to the fixed die 53. The movable die 54 has a cavity 54a which is formed in a shape of a part of the molded article, on that surface of the movable die 54, which is opposed to the fixed die 53.

The positioning pin 55 is provided, for example, on the fixed die 53 so as to be advancible/retreatable. The positioning pin 55 is configured to be able to pierce the thermoplastic prepreg 100 and to fix the thermoplastic prepreg 100, when the thermoplastic prepreg 100 moves toward the fixed die 53 in accordance with the movement of the movable die 54.

For example, when the die 51 has transitioned into the closed state, the positioning pin 55 maintains the state in which the positioning pin 55 is positioned in the cavity 54a of the movable die 54. Thereby, the shape of a part of a molded article is formed by the outer surface of the positioning pin 55. In addition, the positioning pin 55 may be provided such that the positioning pin 55 can advance/retreat to/from the cavity 53a, 54a after the die 51 was set in the closed state. Thereby, the positioning pin 55 may be configured to not form the shape of a part of a molded article by the outer surface of the positioning pin 55.

In the die 51, in its closed state, a space in a shape of the molded article is formed by the cavities 53a and 54a of the fixed die 53 and movable die 54.

The mold clamping device 52 is configured to be able to open/close the die 51, and to be able to perform mold clamping. The mold clamping device 52 is a molding device which forms a molded article. The mold clamping device 52 includes, for example, a fixed platen 56, a movable platen 57 which is movable relative to the fixed platen 56, a toggle mechanism 58 which moves the movable platen 57, and a driving source 59 which drives the toggle mechanism 58.

The fixed platen 56 is configured to be able to support the fixed die 53. The movable platen 57 is configured to be able to support the movable die 54. By being driven by the driving source 59, the toggle mechanism 58 advances/retreats the movable platen 57, relative to the fixed platen 56. The driving source 59 is configured to be able to drive the toggle mechanism 58. The driving source 59 is electrically connected to the control device 19 via a signal line S.

The injection device 15 includes, for example, a housing 61, a cylinder 62, a screw 63, a hopper 64, moving means 65, a driving device 66, and a cylinder heating device 67. The injection device 15 is configured to inject a resin material (molding material) into the die 51 of the die device 14, thereby the injection device 15 is a molding device configured to form a molded article, together with the mold clamping device 52.

The housing 61 is formed, for example, such that the housing 61 can support the cylinder 62, screw 63 and hopper 64, and can accommodate the driving device 66 therein. The cylinder 62 accommodates the screw 63 therein. The cylinder 62 includes an injection nozzle 62a at a distal end thereof. The injection nozzle 62a is configured to be connectable to the gate 53b formed in the die 51. The screw 63 is configured to be rotatable within the cylinder 62 and to be advancible/retreatable relative to the cylinder 62.

The hopper 64 stores a resin material (molding material) to be melted, with which injection molding is performed. The hopper 64 is configured to be able to supply the stored resin material into the cylinder 62.

The moving means 65 includes, for example, a plurality of rails 71 which are disposed on the base 3 and extend towards the fixed die 53 and fixed platen 56, and a plurality of guides 72 which are provided under the housing 61 and are slidably movable on the rails 71. The moving means 65 is configured to be able to advance/retreat the housing 61 and the respective structures supported on the housing 61 along the rails 71 relative to the die device 14, by the guides 72 being guided on the rails 71.

The driving device 66 includes, for example, a first driving device 74 configured to rotate the screw 63, a second driving device 75 configured to advance/retreat the screw 63 relative to the cylinder 62, and a third driving device 76 configured to advance/retreat the hosing 61 along the rails 71 relative to the die device 14.

The first driving device 74 is configured to be able to supply a fixed amount of resin material which is supplied from the hopper 64, by rotating the screw 63. The first driving device 74, second driving device 75 and third driving device 76 are electrically connected to the control device 19 via signal lines S.

The cylinder heating device 67 is configured to be able to heat the cylinder 62. The cylinder heating device 67 is attached to the cylinder 62. The cylinder heating device 67 is configured to be able to melt the resin material supplied from the hopper 64, by heating the cylinder 62. The cylinder heating device 67 is electrically connected to the control device 19 via a signal line S.

The control device 19 is configured to be able to control the conveying device 12, die device 14 and injection device 15. Specifically, the control device 19 is configured to be able to control the moving operation of the chucks 32 (support portion 31), by controlling the conveying mechanism 22. The control device 19 is configured to be able to control the opening/closing operation of the chucks 32, by controlling the opening/closing means 33. The control device 19 is configured to be able to control the cooling of the chucks 32, by controlling the cooling device 34.

The control device 19 is configured to drive the toggle mechanism 58 by controlling the driving source 59, thereby being able to control the advancing/retreating operation of the movable die 54. The control device 19 is configured to control the first driving device 74, second driving device 75 and third driving device 76, thereby being able to control the rotational operation and advancing/retreating operation of the screw 63 and the advancing/retreating operation of the housing 61 (the advancing/retreating operation of the injection device 15). The control device 19 is configured to be able to control the heating operation of the cylinder 62 by controlling the cylinder heating device 67.

Next, a description is given of a method of manufacturing a molded article by using the molded article manufacturing apparatus 1 having the above-described structure.

To start with, the chucks 32 are moved to the storage section 11, and the chucks 32 are set in the open state. In the meantime, when the thermoplastic prepreg 100 was conveyed to the heating device 13 before this cycle, the chucks 32 are cooled by the cooling device 34.

Next, as illustrated in FIG. 2 and FIG. 3, the chucks 32 are further moved, and the distal ends of the fixed claw portions 32a and movable claw portions 32b are positioned at the peripheral edge (edge portion, end portion) of the thermoplastic prepreg 100. Then, as illustrated in FIG. 2 and FIG. 3, the chucks 32 are set in the closed state by moving the movable claw portions 32b, as indicated by a two-dot-and-dash line, and the thermoplastic prepreg 100 is held by the chucks 32. Next, the chucks 32 are moved, the thermoplastic prepreg 100 is moved to a point between the paired heating portions 41, and the thermoplastic prepreg 100 is heated up to a predetermined temperature.

Subsequently, the chucks 32 are moved, the thermoplastic prepreg 100 is conveyed to the die 51 and, as illustrated in FIG. 4, the thermoplastic prepreg 100 is disposed between the fixed die 53 and movable die 54 of the die 51. At this time, the thermoplastic prepreg 100 is disposed such that the thermoplastic prepreg 100 is located at a predetermined position.

Next, the toggle mechanism 58 is driven, and the movable die 54 is moved toward the fixed die 53. At this time, as illustrated in FIG. 5, the thermoplastic prepreg. 100 is pushed toward the fixed die 53 by the movable die 54, and positioning pins 55 provided on the fixed die 53 are made to pierce the thermoplastic prepreg 100 by a predetermined length. Such a configuration may be adopted that, at the time of piercing, the chucks 32 are moved toward the fixed die 53 in sync with the movable die 54.

In the meantime, the predetermined length, in this context, may be such a length that the thermoplastic prepreg 100 can be fixed to the positioning pins 55, and may be, for example, a length of 5 mm to 10 mm. In addition, the chucks 32 are formed in such a shape that the fixed claw portion 32a and movable claw portion 32b do not interfere with the die 51 until the positioning pins 55 fix or hold the thermoplastic prepreg 100 by the predetermined length.

Next, the chucks 32 are set in the open state to release the holding of the thermoplastic prepreg 100, and the chucks 32 are spaced apart from the die 51. Subsequently, the toggle mechanism 58 is further driven to move the movable die 54 toward the fixed die 53, and the die 51 is set in the closed state (mold-clamping state). Thereby, the thermoplastic prepreg 100 is pressed and shaped in accordance with the shapes of the cavities 53a and 54a.

In conjunction with this, the third driving device 76 is driven to move the housing 61, the injection nozzle 62a is connected to the gate 53b that is formed in the fixed die 53, and the resin material (molding material), which is supplied in the cylinder 62 from the hopper 64 and is melted, is injected via the gate 53b. Thereby, as illustrated in FIG. 6, the resin material is injected into the cavity 53a, 54a, and the resin material is supplied in the shape of the cavity 53a, 54a and is molded as one body with the shaped thermoplastic prepreg 100.

Next, the molded thermoplastic prepreg 100 and the resin material are cooled, and a molded article is formed. Then, the movable die 54 is moved, the die 51 is set in the open state, and the molded article is taken out of the die 51 by an extrusion pin that is provided on the fixed die 53 or movable die 54.

In addition, while the processes from the mold-clamping to the removal of the molded article are performed, the chucks 32 are cooled by the cooling device 34, a thermoplastic prepreg 100 is conveyed to the heating device 13 once again, and the thermoplastic prepreg 100 for use in the next molding is heated. Subsequently, the same fabrication processes are repeated. By the repetition of these fabrication processes, molded articles are successively manufactured.

According to the molded article manufacturing device 1 with the above-described structure, the conveying device 12 conveys the thermoplastic prepreg 100 in the vertical attitude, and the thermoplastic prepreg 100 is held by the chucks 32 until the thermoplastic prepreg 100 is fixed or held by the positioning pins 55. Thereby, when the thermoplastic prepreg 100 is inserted into the die 51, the thermoplastic prepreg 100 can be prevented from falling.

In addition, since the thermoplastic prepreg 100 is pierced and fixed by the positioning pins 55, there is no need to form a bore portion for positioning in the thermoplastic prepreg 100 in advance, and the processing cost of the thermoplastic prepreg 100 can be reduced. Furthermore, since no such configuration is adopted in which the positioning pin 55 is inserted into a positioning bore, the thermoplastic prepreg 100 can be surely fixed even if there is a slight misregistration at a time when the thermoplastic prepreg 100 is disposed in the die 51.

In the molded article manufacturing apparatus 1, the conveyance of the thermoplastic prepreg 100 to the die 51, the positioning of the thermoplastic prepreg 100, the fixation of the thermoplastic prepreg 100 to the positioning pins 55, the separation of the chucks 32, and the molding can be executed in a single cycle. Thus, the insert operation can be made shorter.

As has been described above, the molded article manufacturing apparatus 1 can prevent falling of the thermoplastic prepreg 100, can surely insert, the thermoplastic prepreg 100 in the die 51, and can realize a stable molding cycle.

In addition, the positioning pin 55 can constitute a part of a cavity for injection molding, and the degree of freedom of the die 51 can be enhanced. For example, it is possible to form a cylindrical boss of a molded article by the positioning pin 55, and to form a screw hole in a molded article by performing a tapping process on the outer peripheral surface of the positioning pin 55 in a female screw shape. Since this hole is made in a softened state or a molten state, the fabric material is not damaged and a high strength can be obtained.

Furthermore, for example, by configuring the positioning pin 55 to be advancible/retreatable relative to the cavity 53a, 54a, the positioning pin 55 can be pulled out of the thermoplastic prepreg 100 at a time of injection molding in accordance with the shape of the molded article. Incidentally, the hole in the thermoplastic prepreg 100, which is formed by the positioning pin 55, can be closed by injection molding. In addition, by configuring the positioning pin 55 to be advancible/retreatable, when the positioning pin 55 is in the range of drawing of the thermoplastic prepreg 100 at a time of closing the die 51 and performing pressing, a drawing process can be performed by retreating and pulling out the positioning pin before drawing starts.

As has been described above, according to the molded article manufacturing device 1 relating to the embodiment of the invention, the thermoplastic prepreg 100 in a softened state or a molten state can surely be inserted into the die 51.

In the meantime, the present invention is not limited to the above-described embodiment. For example, the positioning pin 55 may be disposed at any position of the thermoplastic prepreg 100, where the thermoplastic prepreg 100 is not affected in the shaping by mold-clamping. In addition, the positioning pin 55 may be disposed at any position of the thermoplastic prepreg 100, if a trace, which would be formed by the positioning pin 55 on the molded article, is of such a degree that the value of the molded article as a product is not degraded by the trace by the positioning pin 55. For example, when the number of positioning pins 55 is one, the positioning pin 55 is disposed on the central axis of the thermoplastic prepreg 100.

In addition, in order to avoid a trace by the positioning pin 55 being left on the molded article, such a configuration may be adopted that the positioning pin 55 is disposed to be able to pierce that part of the thermoplastic prepreg 100, which does not become a product when the thermoplastic prepreg 100 is molded into a molded article; for example, a lug portion 100a which is, as illustrated in FIG. 7 by way of example, formed in a manner to project from the outer periphery of the insert member 100 and is provided only at a time of molding. By disposing the positioning pin 55 in this manner, the product part of the molded article is not affected by the piercing of the positioning pin 55, if the lug portion is removed in a post-step after the manufacture of the molded article. Thus, the quality of the molded article can be enhanced. Incidentally, although the insert member 100 of FIG. 7 has been described as being configured to include the lug portion 100a projecting from the outer periphery thereof, the configuration of the insert member 100 is not limited to this example. Such a configuration may be adopted that a part of the outer periphery of the insert member 100 may be formed as a lug portion, and this part of the outer periphery may be removed after the manufacture of the molded article.

Further, if based on the above gist, it is possible to adopt such a configuration that three positioning pins 55, for example, may be provided, and the axial centers of these positioning pins 55 are arranged in a manner to describe a triangle.

In the above-described example, although a detailed shape of the positioning pin 55 has not been described, it is desirable to use, as the positioning pin 55, a pin with an acute-angled distal end in order to prevent the fabric of the thermoplastic prepreg 100 from being damaged when the positioning pin 55 pierces the thermoplastic prepreg 100.

In addition, in the above-described example, although the description has been given of the configuration in which the molded article manufacturing apparatus 1 includes the injection device 15 and the molded article is formed by the shaping and injection molding of the thermoplastic prepreg 100 by the die device 14 and injection device 15, the molded article manufacturing apparatus 1 is not limited to this configuration. For example, the molded article manufacturing apparatus 1 may be configured to not include the injection device 15 but include only only the die device 14 (e.g., a pressing machine (press-molding machine)) and a molded article is formed by only the shaping of the thermoplastic prepreg 100.

In the above-described example, although the description has only been given of the configuration of the conveying device 12 in which the peripheral edge of the thermoplastic prepreg 100 is held by two chucks 32, the configuration of the conveying device 12 is not limited to this example. For example, such a configuration may be adopted that chucks 32 are provided at two locations of each of the upper and lower parts, or chucks 32 are provided at three locations at the upper edge of the thermoplastic prepreg 100. In addition, the positions at the peripheral edge, which are held by the chucks 32, may be properly set in accordance with the shape of the thermoplastic prepreg 100, and the shapes of the distal ends of the fixed claw portion 32a and movable claw portion 32b may also be properly set. It should be noted, however, that the area, where the chucks 32 come in contact with the thermoplastic prepreg 100, should desirably be as small as possible if the thermoplastic prepreg 100 can be held.

Furthermore, in the above-described example, although the description has been given of the configuration in which the positioning pin 55 is advancible/retreatable, the configuration of the positioning pin 55 is not limited to this example. For example, in the case of the die 51 which is used only for such a molded article that the positioning pin 55 may be located in the cavity 53a, 54a when the molded article is formed, the positioning pin 55 may be configured to be fixed on the fixed die 53, without being advancible/retreatable.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A molded article manufacturing apparatus comprising:
a conveying device configured to convey an insert member in a vertical attitude; and
a die including a positioning pin configured to pierce the insert member which has been conveyed by the conveying device.

2. A method of manufacturing a molded article, comprising:
conveying an insert member in a vertical attitude by a conveying, device to a die including a positioning pin;
piercing the insert member, which has been conveyed by the conveying device, by the positioning pin; and
forming the insert member by the die.

3. The method of claim 2, wherein the positioning pin constitutes a part of a cavity of the die at a time of the forming.

4. The method of claim 2, wherein the positioning pin is disposed, in the die, at a part constituting a lug portion of a molded article.

5. The method of claim 2, wherein a resin material is injected into the die, and is molded as one body with the insert member.

6. The method of claim 3, wherein a resin material is injected into the die, and is molded as one body with the insert member.

7. The method of claim 4, wherein a resin material is injected into the die, and is molded as one body with the insert member.

8. A molded article molded by conveying an insert member in a vertical attitude by a conveying device to a die including a positioning pin, piercing the insert member, which has been conveyed by the conveying device, by the positioning pin, and forming the insert member by the die.
